(19) United States
(12) Patent Application Publication
(10) Pub. No.: US 2009/0297867 A1
(43) Pub. Date: Dec. 3, 2009

(54) SEMICONDUCTOR THIN FILM-ATTACHED SUBSTRATE AND PRODUCTION METHOD THEREOF

(75) Inventors: Takeo KATOH, Tokyo (JP); Kazushige TAKAISHI, Tokyo (JP)

Correspondence Address: GREENBLUM & BERNSTEIN, P.L.C., 1950 ROLAND CLARKE PLACE, RESTON, VA, 20191, US

(73) Assignee: SUMCO CORPORATION, Tokyo (JP)

(21) Appl. No.: 12/476,440

(22) Filed: Jun. 2, 2009

(30) Foreign Application Priority Data
Jun. 3, 2008 (JP) 2008-146225

(51) Int. Cl. B32B 38/10; B32B 9/00

(52) U.S. Cl. 428/446; 156/60

(57) ABSTRACT

An adhesive agent high in thixotropy is coated on the flat surface of a circular glass substrate in a uniform thickness, a silicon wafer equal in diameter is placed thereon, the adhesive agent is cured, and the silicon wafer is pasted together on the glass substrate.

### CROSS-REFERENCE TO RELATED APPLICATIONS

The present application claims priority under 35 U.S.C. §119 of Japanese Application No. 2008-146225 filed on Jun. 3, 2008, the disclosure of which is expressly incorporated by reference herein in its entirety.

### BACKGROUND OF THE INVENTION

1. Field of the Invention

The present invention relates to a semiconductor thin film-attached substrate appropriate for a thin film device and a production method thereof.

2. Description of the Related Art

A semiconductor thin film-attached substrate having a semiconductor thin film on a heterogeneous substrate is known as a substrate appropriate for semiconductor devices, for example, a semiconductor element on an SOI (silicon on insulation) substrate. The semiconductor thin film-attached substrate is used to obtain such an advantage that a circuit is to be operated at higher speeds and at higher reliability.

Japanese Patent Laid Open No. 2003-209229 has disclosed the following method as a method for producing a semiconductor thin film-attached substrate. More specifically, a silicon-element containing a primary coat (phosphosilicate glass layer) is formed on the surface of a silicon substrate for formation of a thin film, thereby forming a crystalline silicon layer on the primary coat, then, a fixed substrate (glass substrate) is closely adhered to a crystalline silicon layer so that they can be pasted together. Thereafter, the primary coat is removed by using HF solution or the like, thereby forming a semiconductor thin film-attached substrate.

However, according to the method described in Japanese Patent Laid Open No. 2003-209229, hydrofluoric acid, which is highly toxic, must be used for removal of the primary coat, thereby posing safety hazard. Further, since a semiconductor thin film is formed by using a CVD (chemical vapor deposition) method, it is necessary to provide a silicon substrate as a thin-film forming substrate higher in heat resistance. Further, it is difficult to produce semiconductor thin film-attached substrates at lower costs due to a greater number of steps.

### SUMMARY OF THE INVENTION

Under these circumstances, a non-limiting feature of the present invention is to provide a semiconductor thin film-attached substrate which can be produced at lower costs and safely and also a production method thereof.

A non-limiting aspect of the invention provides a semiconductor thin film-attached substrate in which on the surface of a fixed substrate having a flat surface the back face of which the semiconductor thin film is formed with a semiconductor material and the shape of which is the same as that of the fixed substrate in a planar view is pasted together so as not to deviate by means of a heat-resistant adhesive agent which is coated all over the surface of the fixed substrate in a uniform thickness.

According to this aspect of the invention, a semiconductor wafer is directly pasted together on the fixed substrate to make the semiconductor wafer into a thin film thereafter. Therefore, eliminated is the necessity for providing a primary coat (peeled layer) or depositing and growing a single crystal silicon layer on the primary coat, thereby making it possible to produce efficiently semiconductor thin film-attached substrates.

Further, a step for removing the primary coat is not needed, by which it is possible to produce semiconductor thin film-attached substrates safely without using toxic chemicals such as hydrofluoric acid.

The above-described fixed substrate is a glass substrate, a plastic substrate or the like, and used as a substrate for loading a thin film device.

No restriction is given to types of semiconductor thin films, and there is used a single crystal thin film having a cleavage face, for example, a single crystal silicon thin film.

As the above-described heat-resistant adhesive agent, there may be used a liquid adhesive agent high in thixotropy, for example, an adhesive agent which is four or more in the thixotropy index and favorable in shape retaining properties. Then, this adhesive agent is made with a material curable at room temperature or higher temperatures. Further, the heat-resistant adhesive agent is able to withstand high temperature environments (for example, approximately 900° C.) in a device process.

As the heat-resistant adhesive agent, there may be used a ceramic adhesive agent high in thixotropy.

Thixotropy means the property which is liquefied when an external force is given but again turns into a gel when allowed to stand. An adhesive agent high in thixotropy includes “Themeez 7030” (trade name) which maintains adhesive strength at a temperature up to 980° C., for example.

There may be used a silicon thin film as the semiconductor thin film.

A second non-limiting aspect of the present invention provides a method for producing a semiconductor thin film-attached substrate in which a fixed substrate having a flat surface and a semiconductor wafer, the shape of which is the same as that of the fixed substrate in a planar view are provided, a heat-resistant liquid adhesive agent is coated all over the surface of the fixed substrate, the back face of the semiconductor wafer is pasted together so as not to deviate on the surface of the fixed substrate on which the heat-resistant adhesive agent is coated by means of the heat-resistant adhesive agent, and after they are pasted together, the heat-resistant adhesive agent is cured, and the semiconductor wafer is thinned after the curing.

In thinning a semiconductor wafer, it is preferable to adopt a method in which ions are implanted to a predetermined depth position of the wafer from the surface of the semiconductor wafer, thereafter, thermal treatment is conducted at high temperatures (heating at 500° C., for example), thereby, peeling substantially the semiconductor wafer to form a thin film, with a fixed substrate remaining on a thin film layer. Alternatively, the semiconductor wafer is cut down to a desired thickness, thereafter, the thus cut face is subjected to mirror polishing which is publicly known, thereby forming the semiconductor thin film with a desired thickness on the fixed substrate. Further, the adhesive agent may be coated on the fixed substrate by using a brush, for example, so as to give a uniform thickness all over the surface thereof.

In coating the adhesive agent, there may be used a method in which a heat-resistant adhesive agent is coated by using a coater all over on the surface of the fixed substrate so as to give a uniform thickness.

The coater is a coating machine which coats liquid samples on the surface of a fixed substrate or that of a semiconductor wafer in a uniform thickness. It is available as a bar coater or a spin coater, coating the heat-resistant adhesive agent on the surface of the fixed substrate.

In thinning a film, there may be adopted a method in which at least one type of hydrogen ions and rare gas ions are implanted from the surface of a semiconductor wafer to form an ion implantation layer inside the semiconductor wafer, thermal treatment is conducted at high temperatures to peel a part to the semiconductor wafer, with the ion implantation layer given as a boundary, thereby forming the semiconductor thin film.

In this instance, the semiconductor wafer separated from the fixed substrate due to the peeling after ion implantation is provided with a sufficient thickness and can be reused as a semiconductor single crystal wafer. Therefore, it is possible to promote resource savings of semiconductor materials as a whole, reduce the overall production costs of semiconductor thin film-attached substrates and also decrease waste materials occurring during production.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a pattern diagram showing a production method for a semiconductor thin film-attached substrate in an embodiment of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice. Hereinafter, a description will be given for an embodiment of the present invention. It is noted that the following embodiment is only one example of the present invention to which the present invention shall not be limited. With reference to the present embodiment, a description will be given for a silicon thin film-attached glass substrate as the semiconductor thin film-attached substrate.

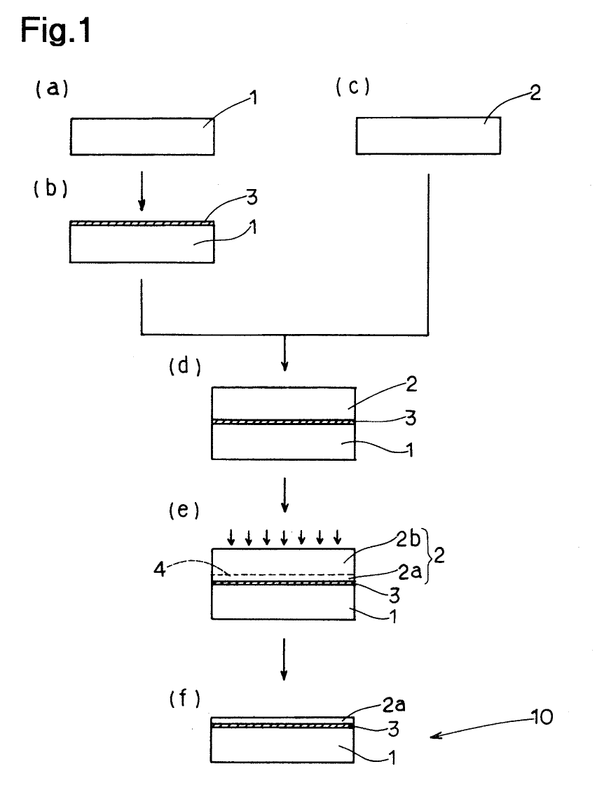

As shown in FIG. 1 (f), the above-described silicon thin film-attached glass substrate 10 is constituted with a glass substrate 1 as a fixed substrate, a silicon thin film 2a deposited to the glass substrate 1, and a heat-resistant adhesive agent layer 3 for covering the silicon thin film 2a on the glass substrate 1.

The glass substrate 1 is a circular plate made of quartz-glass which is 450 mm in diameter and 1 mm in thickness, for example.

The silicon thin film 2a is a thin film layer obtained by thinning a CZ process-based silicon wafer which is 450 mm in diameter and 925 μm in thickness, for example. This thin film layer is from 10 to 50 μm in thickness.

The heat-resistant adhesive agent layer 3 is a layer formed with a thermosetting ceramic adhesive agent high in thixotropy in which a filler (silica) and a water-soluble resin are dispersed in water (“Thermeez 7030”, trade name). The thickness is approximately 50 μm, for example. It is noted that the glass substrate is to be 300 mm in diameter, where a silicon wafer at a size of 300 mm is used.

In the silicon thin film-attached glass substrate 10, the heat-resistant adhesive agent 3 which is 10 μm in thickness, for example, is coated uniformly all over the surface of the glass substrate 1. The silicon thin film 2a is fixed on the heat-resistant adhesive agent 3. The glass substrate 1 and the silicon thin film 2a are fixed so as not to deviate. More specifically, the glass substrate 1 is completely adhered to the silicon thin film 2a, and in a planar view, they are pasted together in a state that an outer circumferential edge of the silicon thin film 2a is overlaid over the entire outer circumferential edge of the glass substrate 1 with complete correspondence.

Next, a description will be given for a method for producing a silicon thin film-attached glass substrate 10 which is constituted as above.

First, provided are a glass substrate 1 and a silicon wafer 2 (FIG. 1 (a) and FIG. 1(c)).

The silicon wafer 2 is obtained by subjecting a single crystal silicon ingot grown by the CZ method from known steps such as cutting into blocks, slicing, beveling and mirror polishing. The silicon wafer 2 is a circular plate which is 925 μm in thickness and 450 mm in diameter, for example, and the surface of which is mirror-polished. Thereafter, the silicon wafer 2 is subjected to thermal oxidation treatment at 900° C. in an oxygen gas atmosphere, for example, depending on an application, thereby an exposed face of the silicon wafer 2 may be coated all over by using a silicon oxide film. Further, a notch and an orientation flat may be formed on the silicon wafer 2.

The glass substrate 1 is a quartz glass-made substrate having the same circular shape as that of the silicon wafer 2 in a planar view. The surface of the glass substrate 1 is flat. For example, the glass substrate 1 is substantially equal in planarization to the mirror-finished surface of the silicon wafer 2. In the present embodiment, used is a quartz glass-made circular substrate which is 450 mm in diameter and 1 mm in thickness.

Next, the heat-resistant adhesive agent 3 is coated all over the surface of the glass substrate 1 (FIG. 1 (b)). As described above, the heat-resistant adhesive agent 3 is a thermosetting ceramic adhesive agent high in thixotropy in which a filler (silica) and a water-soluble resin are dispersed in water. The heat-resistant adhesive agent 3 has resistance to high temperatures which will be made non-adhesive at a temperature (for example, 980° C.) exceeding the highest temperature in a subsequent device process. Therefore, in the device process, on the silicon thin film-attached glass substrate 10, there is no chance that the silicon thin film 2a is peeled from the glass substrate 1. Further, thereafter, for example, the silicon thin film 2a can be easily separated from the glass substrate 1 by being heated at 980° C. or higher. In the present embodiment, “Thermeez 7030” (made by Taiyo Wire Cloth Co., Ltd.) was used as the heat-resistant adhesive agent 3.

The heat-resistant adhesive agent 3 is coated all over on the surface of the glass substrate 1 by using a coater. More specifically, the heat-resistant adhesive agent 3 is dripped in a small amount at the center of the surface of the circular glass substrate 1 and a spin coater is used to rotate the glass substrate 1 at a predetermined speed. Thereby, the heat-resistant adhesive agent 3 is coated in a generally uniform thickness all over on the surface of the glass substrate 1. Alternatively, in place of the spin coater, a bar coater may be used to coat in a uniform thickness the heat-resistant adhesive agent 3 all over the surface of the glass substrate 1.

After the heat-resistant adhesive agent 3 is coated all over on the surface of the glass substrate 1, the surface of the silicon wafer 2 is pasted together on the surface of the glass substrate 1 so that their outer circumferential edges overlay each other with complete correspondence (FIG. 1 (d)). In this instance, they are pasted together so that the glass substrate 1 will not deviate from the silicon wafer 2 (their outer circumferential edges are in correspondence with each other, in a planar view). They are pasted together, for example, by using an automatic pasting machine. More specifically, in the automatic pasting machine, the back face of the glass substrate 1 having an adhesive-agent layer on the surface is stuck so as to be horizontal with respect to a retaining base, and the back face of the silicon wafer 2 is stuck by using a pressing tool for sticking, for example. Then, the pressing tool by which the silicon wafer 2 has been stuck moves by automatic control to a position immediately above a site at which the glass substrate 1 is placed. Then, the pressing tool is moved downward to press the lower face of the silicon wafer 2 (surface) on the upper face of the glass substrate 1 (surface). Thereby, the glass substrate 1 is overlaid on the silicon wafer 2 via the layer of the adhesive agent 3.

It is noted that when they are overlaid, care must be taken so that no contamination is found on the surface of the glass substrate 1 or the back face of the silicon wafer 2.

After they are thus overlaid, the heat-resistant adhesive agent 3 is cured. As a result, the silicon wafer 2 is to be pasted together on the glass substrate 1. As described above, the heat-resistant adhesive agent 3 is thermally cured. Therefore, the glass substrate 1 overlaid on the silicon wafer 2 is heated for approximately 30 to 60 minutes at temperatures of 120° C. to 200° C. Curing means that components of an adhesive agent are changed to a solid by physical actions or chemical reactions. In order to facilitate the curing, a cure accelerator may be added to the heat-resistant adhesive agent 3.

A sufficient curing is needed. The sufficient curing means that an adhesive agent is fully cured. More specifically, it means that an adhesive agent undergoes a structural change by physical actions or chemical reactions and is cured until the development of adhesive characteristics. This is because where the curing is insufficient, the silicon wafer 2 will deviate from the glass substrate 1 in a subsequent film thinning step.

Heating may be conducted by using an ordinary dryer and preferably by using a vacuum dryer in view of preventing possible contamination.

After the heat-resistant adhesive agent 3 is cured, the silicon wafer 2 is made into a thin film. More specifically, a medium current ion implanter is used to implant hydrogen ions at an acceleration voltage of 50 keV at a predetermined depth position from the mirror-polished surface of the silicon wafer 10 (FIG. 1 (e)). In this instance, the dosage is 5×10¹⁶ ions/cm². In FIG. 1, the number 4 denotes a hydrogen ion implantation layer. Ions used for this ion implantation may be rare gas elements such as helium, neon, argon, krypton, xenon, radon, in addition to hydrogen. Further, their simple substances or compounds may be usable.

Thereafter, a pasted body of the glass substrate 1 with the silicon wafer 2 is put into a thermal treatment apparatus for peeling and the pasted body is thermally treated for 30 minutes, for example, at a furnace temperature of 500° C. in a nitrogen gas atmosphere (argon gas or oxygen gas will do). Thereby, the silicon wafer 2b is substantially peeled on the glass substrate 1, while the silicon thin film 2a remains, with the ion implantation layer 4 given as a boundary (FIG. 1 (f)).

After the peeling, the surface of the silicon thin film 2a remaining in an integrated manner with the glass substrate 1 is subjected to predetermined mirror polishing and surface washing. As described so far, formed is a silicon thin film-attached substrate 10 which is 50 μm in thickness and having on the glass substrate 1 the silicon thin film 2a, the surface of which is mirror polished.

The thus produced silicon thin film-attached substrate 10 is provided with a desired device on the silicon thin film 2a in a device process. After the device formation, thermal treatment is conducted at a temperature exceeding a temperature given in the device process (for example, 980° C.). At this time, the heat-resistant adhesive agent 3 is made non-adhesive and the silicon thin film 2a is peeled from the glass substrate 1. Thereafter, the silicon thin film 2a after the device formation is subjected to dicing, for example, thereby forming semiconductor chips with a thin film.

As described above, the silicon thin film-attached substrate 10 is used to easily produce semiconductor chips which are thinned.

As a matter of course, a type of adhesive agent or a film thinning process shall not be limited to those described in the above embodiment.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A semiconductor thin film-attached substrate, comprising:
a fixed substrate having a generally flat surface; and
a semiconductor thin film comprising a semiconductor material, wherein a shape of the semiconductor thin film is generally the same as a shape of the fixed substrate in planar view, and wherein the semiconductor thin film and the fixed substrate are fixedly pasted together by a heat-resistant adhesive agent coated over a surface of the fixed substrate in a generally uniform thickness.

2. A method for producing a semiconductor thin film-attached substrate, wherein a fixed substrate having a flat surface and a semiconductor wafer, the shape of which is the same as that of the fixed substrate in a planar view are provided, the method comprising:
coating a heat-resistant liquid adhesive agent over the surface of the fixed substrate;
pasting, via the heat-resistant adhesive agent, a back face of the semiconductor wafer and the fixed substrate together so as not to deviate on the surface of the fixed substrate on which the heat-resistant adhesive agent is coated;
curing the heat-resistant adhesive agent after said pasting; and
thinning the semiconductor wafer after said curing.
